(19) United States
(12) Patent Application Publication
(10) Pub. No.: US 2026/0023194 A1
(43) Pub. Date: Jan. 22, 2026

(54) FLASH FLOOD SIMULATION METHOD APPLICABLE TO RED-BED SOFT ROCK REGIONS

(71) Applicant: SUN YAT-SEN UNIVERSITY, Guangzhou (CN)

(72) Inventors: Kairong LIN, Zhuhai (CN); Xingyu FENG, Zhuhai (CN); Luwen ZHUANG, Zhuhai (CN)

(73) Assignee: SUN YAT-SEN UNIVERSITY, Guangzhou (CN)

(21) Appl. No.: 19/255,040

(22) Filed: Jun. 30, 2025

(30) Foreign Application Priority Data
Jul. 18, 2024 (CN) 2024109627411

(51) Int. Cl. G01V 20/00; G06F 30/28; G06F 111/10

(52) U.S. Cl. CPC G01V 20/00; G06F 30/28; G06F 2111/10

(57) ABSTRACT

A flash flood simulation method includes: obtaining a water storage in a vegetation root zone and obtaining an actual evaporation at any point in the vegetation root zone within a target watershed; obtaining a total infiltration rate in an unsaturated zone based on an infiltration model; obtaining a saturation overland flow and an interflow based on a vertical distance from a wetting front to a slope surface; updating an average saturated groundwater table depth based on the interflow and the total infiltration rate of the unsaturated zone; constructing a flash flood model for the target watershed based on the water storage of the vegetation root zone, the actual evaporation, the total infiltration rate of the unsaturated zone, the saturation overland flow, the interflow, and the average saturated groundwater table depth; and simulating an event-based flood hydrograph of the target watershed based on the flash flood model for the target watershed.

### CROSS-REFERENCE TO RELATED APPLICATION

This application is filed on the basis of Chinese patent application No. 202410962741.1 filed Jul. 18, 2024, and claims priority to the Chinese patent application, the entire contents of which are incorporated herein by reference.

### TECHNICAL FIELD

The present disclosure relates to the field of flash flood simulation technology, particularly to a flash flood simulation method applicable to red-bed soft rock regions.

### BACKGROUND

Current flash flood simulation methods mostly adopt generic soil hydrological parameters, failing to fully consider the unique characteristics of red-bed soft rock, such as low permeability, high water storage, and susceptibility to weathering. This results in the parameter settings and physical process descriptions of the models not accurately reflecting the actual conditions in the hydrological process simulations of these regions. Moreover, current flash flood simulation methods lack refined quantitative characterization of soil moisture, resulting in a relatively rough simulation of soil moisture changes, which cannot accurately reflect the dynamics of soil moisture in red-bed soft rock regions. Due to the complex landform of the red-bed soft rock regions, and the significant impact of the landform on rainfall runoff in the red-bed soft rock regions, these models often lack sufficient accuracy and capability when dealing with complex landforms and geomorphological features. This lack of accuracy can directly affect the forecasts of flash flood occurrence and development.

### SUMMARY

The present disclosure provides a flash flood simulation method.

A first aspect of the embodiments of the present disclosure provides a flash flood simulation method applicable to red-bed soft rock regions, including:
obtaining a water storage in a vegetation root zone and obtaining an actual evaporation at any point in the vegetation root zone within a target watershed;
obtaining a total infiltration rate in an unsaturated zone based on an infiltration model;
obtaining a saturation overland flow and an interflow based on a vertical distance from a wetting front to a slope surface;
updating an average saturated groundwater table depth at the end of each time interval based on the interflow and the total infiltration rate of the unsaturated zone;
constructing a flash flood model for the target watershed based on the water storage of the vegetation root zone, the actual evaporation, the total infiltration rate of the unsaturated zone, the saturation overland flow, the interflow, and the average saturated groundwater table depth at the end of each time interval; and
simulating an event-based flood hydrograph of the target watershed based on the flash flood model for the target watershed to obtain simulation results.

In some embodiments, the flash flood simulation method applicable to red-bed soft rock regions further includes: dividing a soil water storage layer into the vegetation root zone, the unsaturated zone, and a saturated groundwater zone.

In some embodiments, obtaining an actual evaporation at any point in the root zone within a target watershed includes:
obtaining a potential evaporation based on an actual water evaporation in the target watershed;
obtaining the water storage in the vegetation root zone;
obtaining a maximum moisture capacity of the vegetation root zone at any point within the target watershed; and
obtaining the actual evaporation based on the potential evaporation, the water storage in the vegetation root zone, and the maximum moisture capacity.

In some embodiments, the flash flood simulation method applicable to red-bed soft rock regions further includes: obtaining the water storage at the wetting front through experiments measuring water storage of red-bed soft rock soil mass.

In some embodiments, obtaining a total infiltration rate in an unsaturated zone based on an infiltration model includes:
obtaining a matric suction at any depth of soil based on a vertical distance from the any depth of soil to the slope surface, a matric suction at the wetting front, and the vertical distance from the wetting front to the slope surface;
obtaining a first expression for water storage of soil mass at any depth in a wetted zone based on the infiltration model and the matric suction at any depth of soil;
obtaining a first cumulative infiltration from rainfall based on the first expression for water storage of soil mass;
obtaining a second expression for water storage of soil mass at any depth in the wetted zone based on the water storage at the wetting front and the first expression for water storage of soil mass;
obtaining a second cumulative infiltration based on the first cumulative infiltration and the second expression for water storage of soil mass;
obtaining an infiltration rate based on the second cumulative infiltration; and
obtaining the total infiltration rate in the unsaturated zone based on the infiltration rate through a weighted averaging method.

In some embodiments, the flash flood simulation method applicable to red-bed soft rock regions further includes:
setting a first preset condition, a second preset condition, and a third preset condition;
obtaining a watershed runoff generation rate and a unit-width catchment area based on the first preset condition;
obtaining a first expression of interflow velocity based on the watershed runoff generation rate and the unit-width catchment area;
obtaining a hydraulic conductivity at any point and a surface slope at the any point based on the second preset condition;
obtaining a second expression of interflow velocity based on the hydraulic conductivity and the surface slope at the any point;
obtaining a saturated hydraulic conductivity of soil and a maximum water storage depth of the unsaturated zone based on the third preset condition;
obtaining a functional relationship between the saturated hydraulic conductivity of soil and the vertical distance from the wetting front to the slope surface based on the saturated hydraulic conductivity of soil and the maximum water storage depth; and
obtaining the vertical distance from the wetting front to the slope surface based on the first expression of interflow velocity, the second expression of interflow velocity, and the functional relationship.

In some embodiments, the first preset condition specifies that the interflow in a water-bearing layer is in a stable state, and a unit-width interflow rate at any point in the target watershed is equal to an upstream inflow discharge; the second preset condition specifies that the difference between a hydraulic gradient of saturated groundwater and the surface slope is less than one percent of an absolute value of the surface slope; and the third preset condition specifies that the saturated hydraulic conductivity of soil is negatively correlated with the vertical distance from the wetting front to the slope surface.

In some embodiments, obtaining a saturation overland flow and an interflow based on a vertical distance from a wetting front to a slope surface includes:
obtaining the saturation overland flow when the vertical distance from the wetting front to the slope surface is less than zero and hence exfiltration of saturated groundwater occurs; and
obtaining the interflow based on the vertical distance from the wetting front to the slope surface, the saturated hydraulic conductivity of soil, the surface slope, and the maximum water storage depth.

In some embodiments, the flash flood simulation method applicable to red-bed soft rock regions further includes: obtaining an initial average saturated groundwater table depth before rainfall based on an initial interflow of the target watershed and the maximum water storage depth of the unsaturated zone.

In some embodiments, updating an average saturated groundwater table depth at the end of each time interval based on the interflow and the total infiltration rate of the unsaturated zone includes the following sub-step: obtaining an average saturated groundwater table depth at a next time point based on a total infiltration rate of the unsaturated zone at a current time point, the interflow at the current time point, and the average saturated groundwater table depth at the current time point.

A second aspect of the embodiments of the present disclosure proposes a flash flood simulation device applicable to red-bed soft rock regions, the device including:
a first module configured to obtain a water storage in a vegetation root zone and obtain an actual evaporation at any point in the vegetation root zone within a target watershed;
a second module configured obtain a total infiltration rate in an unsaturated zone based on an infiltration model;
a third module configured to obtain a saturation overland flow and an interflow based on a vertical distance from a wetting front to a slope surface;
a fourth module configured to update an average saturated groundwater table depth at the end of each time interval based on the interflow and the total infiltration rate of the unsaturated zone;
a fifth module configured to construct a flash flood model for the target watershed based on the water storage of the vegetation root zone, the actual evaporation, the total infiltration rate of the unsaturated zone, the saturation overland flow, the interflow, and the average saturated groundwater table depth at the end of each time interval; and
a sixth module configured to simulate an event-based flood hydrograph of the target watershed based on the flash flood model for the target watershed to obtain simulation results.

A third aspect of the embodiments of the present disclosure provides an electronic device, including a memory and a processor, where the memory stores a computer program which, when executed by the processor, causes the processor to perform the aforementioned flash flood simulation method applicable to red-bed soft rock regions.

A fourth aspect of the embodiments of the present disclosure provides a computer-readable storage medium storing a computer program which, when executed by a processor, causes the processor to perform the aforementioned flash flood simulation method applicable to red-bed soft rock regions.

A fifth aspect of the embodiments of the present disclosure provides a computer program product or computer program including computer instructions stored in a computer-readable storage medium. The processor of the computer device can read the computer instructions from the computer-readable storage medium, and the processor executes the computer instructions to cause the computer device to perform the aforementioned flash flood simulation method applicable to red-bed soft rock regions.

### BRIEF DESCRIPTION OF DRAWINGS

In order to illustrate more clearly technical schemes in embodiments of the present disclosure or the related art, the accompanying drawings used in description of the embodiments will be briefly described below, and obviously, the accompanying drawings in the following description show only some embodiments of the present disclosure, and for those having ordinary skill in the art, other drawings can be derived on the basis of these drawings without any inventive effort.

FIG. 1 is a flowchart of a flash flood simulation method applicable to red-bed soft rock regions according to an embodiment of the present disclosure;

FIG. 2 is a conceptual diagram of the runoff generation principle according to an embodiment of the present disclosure;

FIG. 3 is a schematic diagram of soil mass profile water storage according to an embodiment of the present disclosure;

FIG. 4 is a schematic diagram of landform of an experimental region according to an embodiment of the present disclosure;

FIG. 5 shows flood simulation results for the experimental region according to an embodiment of the present disclosure; and

FIG. 6 is a schematic diagram of a hardware structure of an electronic device according to an embodiment of the present disclosure.

### DETAILED DESCRIPTION

In order to make the objectives, technical schemes and advantages of the present disclosure more apparent, the present disclosure is further described in detail in conjunction with the accompanying drawings and embodiments. It should be understood that the specific embodiments described here are intended only to explain the present disclosure and are not intended to limit the present disclosure. The implementations described in the following exemplary embodiments do not represent all implementations that are consistent with the embodiments of the present disclosure. They are merely examples of devices and methods that are consistent with certain aspects of the embodiments of the present disclosure as detailed in the appended claims.

It can be understood that the terms used in the present disclosure, such as “first,” “second,” and so on, may be used in this document to describe various concepts. However, unless specifically stated otherwise, these concepts are not limited by these terms. These terms are used only to distinguish one concept from another concept. For example, without departing from the scope of the embodiments of the present disclosure, the first information may also be referred to as the second information. Similarly, the second information may also be referred to as the first information. Depending on the context, the word “if” or “should” as used herein may be interpreted as “once”, or “when”, or “in response to determining that”.

The terms used in the present disclosure, such as “at least one”, “plurality”, “each”, and “any one”, mean that at least one includes one, two, or more than two; plurality includes two or more than two; each refers to each one of the corresponding plurality; and any one refers to any one of the plurality.

Unless otherwise defined, all the technical and scientific terms used herein have the same meanings as those commonly understood by those skilled in the art to which the present disclosure pertains. The terminology used herein is for the purpose of describing embodiments of the present disclosure only and is not intended to limit the present disclosure.

Before providing a detailed description of the embodiments of the present disclosure, an explanation of certain nouns and terms involved in the embodiments of the present disclosure will be given. The nouns and terms involved in the embodiments of the present disclosure are applicable to the following explanations.

Red-bed landform: it is an erosion landform developed on top of red-bed rock, primarily driven by flowing water, and formed under the combined action of weathering, corrosion, gravity, and other external forces. Red beds, which has a relatively young geological age and has undergone fewer tectonic movements, typically exhibit gentle bedding attitudes. However, due to incomplete diagenesis and consequent low rock strength, they are generally classified as soft rocks.

Matric suction: in the pores of unsaturated soil, there is not only water but also air. The water-air interface (contractile skin) possesses surface tension. In unsaturated soil, the pore air pressure and pore water pressure are not equal, and the pore air pressure is greater than the pore water pressure. The contractile skin is therefore subjected to air pressure that exceeds the water pressure. This pressure difference is referred to as matric suction.

Soil-water characteristic curve: The soil-water characteristic curve is an important relationship curve in the study of unsaturated soil mechanics, commonly used to describe the relationship between matric suction and saturation degree, gravimetric water storage, or volumetric water storage in unsaturated soil.

Van Genuchten (VG) model: The VG model is a mathematical model used to describe the soil-water characteristic curve in unsaturated soil. With its clear physical significance and comprehensive consideration of the entire soil moisture range, it has demonstrated good applicability for soil mass in red-bed soft rock regions.

Distributed hydrological model: It is a mathematical model established based on hydrological process theory and computational methods, capable of relatively accurate simulations of hydrological processes over multiple time scales. Generally speaking, process-based hydrological models have advantages in characterizing spatial heterogeneity and temporal development using information of soil, topography, and vegetation, while multi-scale hydrological models combine large-scale and small-scale models to simulate hydrological processes at different scales.

In red bed soft rocks, claystones and argillaceous siltstones constitute a predominant proportion. Even within sandy conglomerate red beds, multiple claystone interlayers are present, exhibiting a distinctive characteristic of alternating soft and hard strata. Claystones exhibit desiccation cracking upon water loss and rapid disintegration upon water contact. Furthermore, when the natural ecological evolution in red bed terrains is disrupted by abnormal natural events or human activities, the destruction of surface vegetation leads to accelerated soil erosion and land degradation. Under heavy rainfall conditions, this susceptibility triggers secondary hazards such as landslides and mudflows. The red-bed landform region has a high prevalence of bare rock, low vegetation coverage, thin soil layers, and weak surface water infiltration capacity. As a result, the surface runoff generated under heavy rain conditions is often several times or even hundreds of times greater than that of other landform regions, making it prone to flood disasters. In addition, the softening effect of short-duration heavy rainfall infiltration in red-bed landform regions reduces the mechanical strength of rock masses and fillings in fractures, and increases the water storage, bulk density, and hydrostatic pressure of the rock mass, thereby affecting rock stability, and leading to frequent occurrences of collapse and landslide disasters.

Current flash flood simulation methods mostly adopt generic soil hydrological parameters, thereby failing to fully consider the unique characteristics of red-bed soft rock, such as low permeability, high water storage, and susceptibility to weathering. This results in the parameter settings and physical process descriptions of the models not accurately reflecting the actual conditions in the hydrological process simulations of these regions. Moreover, current flash flood simulation methods lack refined quantitative characterization of soil moisture, resulting in a relatively rough simulation of soil moisture changes, which cannot accurately reflect the dynamics of soil moisture in red-bed soft rock regions. Due to the complex landform of the red-bed soft rock regions, and the significant impact of the landform on rainfall runoff in the red-bed soft rock regions, these models often lack sufficient accuracy and capability when dealing with complex landforms and geomorphological features. This lack of accuracy can directly affect the forecasts of flash flood occurrence and development.

Current distributed hydrological models based on local calibration improve forecast accuracy in specific regions by using local measured data for calibration and adjusting model parameters. However, these methods still fail to fully consider the characteristics of red-bed soft rock, such as low permeability, high water storage, and susceptibility to weathering, resulting in limited application effectiveness in red-bed soft rock regions. In addition, although multi-scale hydrological models combine large-scale and small-scale models to simulate hydrological processes at different scales, the lack of specific corrections for the characteristics of red-bed soft rock results in low forecast accuracy.

In view of this, the embodiments of the present disclosure improve the accuracy of flash flood forecasting by measuring and fitting soil infiltration characteristics in red-bed soft rock regions, and dynamically adjusting hydrological model parameters, thereby enabling accurate description of infiltration and surface runoff processes during rainfall in red-bed soft rock regions prone to flash floods. The embodiments of the present disclosure address the special geological conditions of red-bed soft rock regions by introducing specific correction parameters into the infiltration module of the semi-distributed hydrological model, including but not limited to water storage at the wetting front, saturated water storage of soil mass, depth to saturated groundwater (i.e., vertical distance from the wetting front to the slope surface) etc., thereby enabling the model to accurately reflect the geological characteristics and hydrological processes of red-bed soft rock regions to improve the accuracy of flash flood forecasts. This targeted optimization significantly improves the application effectiveness of the model in red-bed soft rock regions, thereby enabling better support for disaster prevention and reduction efforts as compared to the related models.

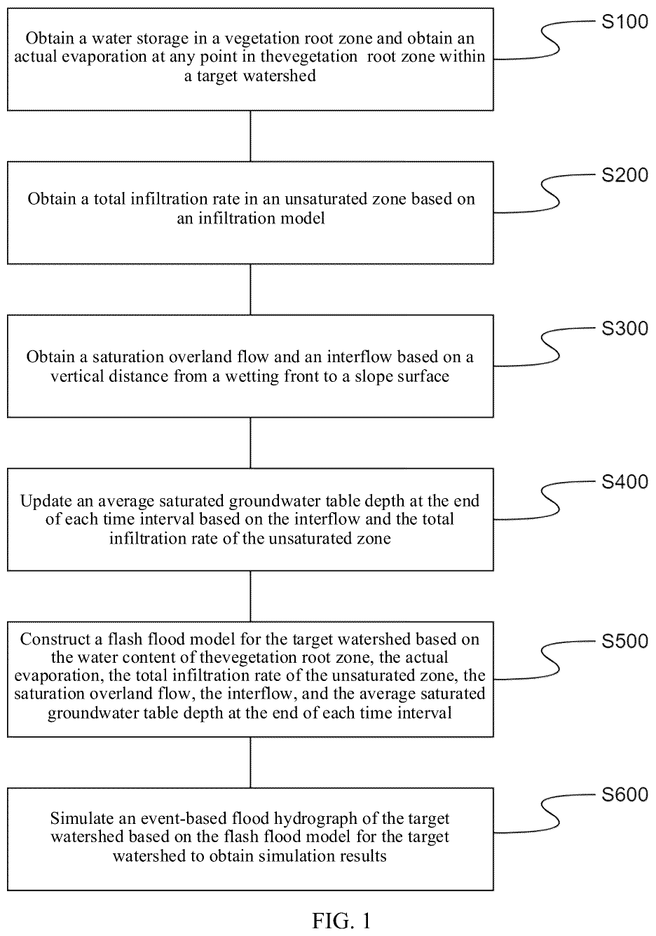

FIG. 1 is an optional flowchart of a flash flood simulation method applicable to red-bed soft rock regions according to an embodiment of the present disclosure. The method in FIG. 1 may include, but is not limited to, a plurality steps S100 to S600.

At the step S100, a water storage in a vegetation root zone and an actual evaporation at any point in the vegetation root zone within a target watershed are obtained.

At the step S200, a total infiltration rate in an unsaturated zone is obtained based on an infiltration model.

At the step S300, a saturation overland flow and an interflow are obtained based on a vertical distance from a wetting front to a slope surface.

At the step S400, an average saturated underground water depth at the end of each time interval is updated based on the interflow and the total infiltration rate of the unsaturated zone.

At the step S500, a flash flood model for the target watershed is constructed based on the water storage of the vegetation root zone, the actual evaporation, the total infiltration rate of the unsaturated zone, the saturation overland flow, the interflow, and the average saturated groundwater depth at the end of each time interval.

At the step S600, an event-based flood hydrograph of the target watershed is simulated based on the flash flood model for the target watershed to obtain simulation results.

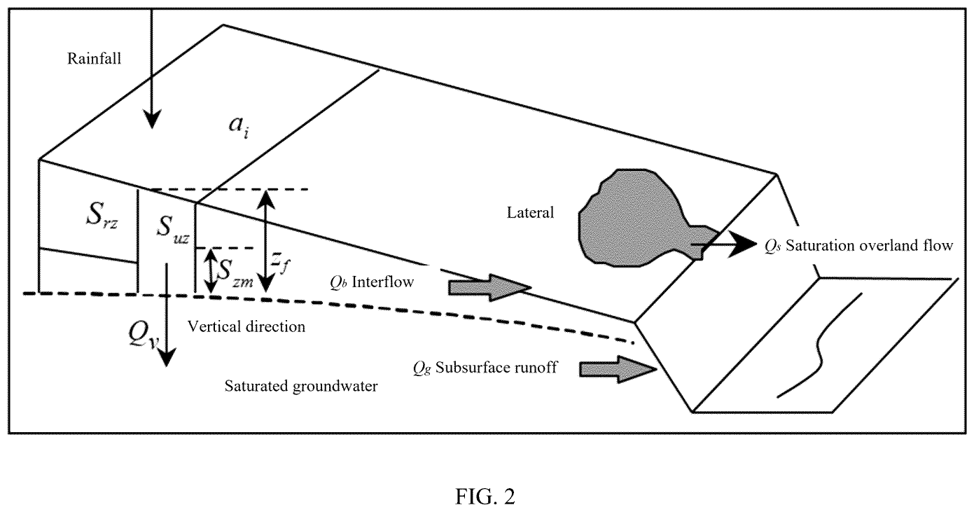

As shown in FIG. 2, in some embodiments, the flash flood simulation method applicable to red-bed soft rock regions also includes a step S700.

At the step S700, a soil water storage layer is divided into the vegetation root zone, the unsaturated zone, and a saturated groundwater zone.

In the step S700 of some embodiments, the soil water storage layer is divided into the vegetation root zone S_{rz}, the unsaturated zone S_{uz}, and the saturated groundwater zone as shown in FIG. 2. The saturated groundwater zone can be represented by the depth from the saturated groundwater to the surface of the watershed soil, i.e., the vertical distance from the wetting front to the slope surface Z_{f} (also referred to as water deficit depth). Additionally, FIG. 2 also illustrates the water movement from the unsaturated zone into the saturated groundwater zone vertically under the influence of gravity, i.e., the total infiltration rate of the unsaturated zone Qᵥ; the interflow Q_{b}, i.e., base flow; the saturation overland flow Qₛ; and the interflow and saturation overland flow together constitute the total runoff of the watershed Qₒᵤₜ, i.e., Qₒᵤₜ=Qₛ+Q_{b}.

Referring to FIG. 2, for example, it is assumed that the water flow according to the follow law: rainfall sequentially compensates the water deficit of each soil layer from top to bottom, and water continues downward movement to the next soil layer only when the water storage of the upper layer reaches saturation. Initial losses are mainly due to canopy interception, filling of depressions, and plant interception, with the excess beginning to infiltrate into the unsaturated soil layer. The unsaturated zone can be further divided into a root zone water storage layer and an inactive water-bearing layer. The infiltrated water directly compensates for the water deficit of the root zone water storage layer until saturation is reached, that is, until the field capacity is achieved, and then the remaining water continues to move downward into the inactive water-bearing layer. Additionally, evaporation from the underlying surface of the watershed also occurs in the unsaturated layer of the soil, where the water undergoes evapotranspiration at a certain rate until being depleted. In the inactive water-bearing layer, only a portion of water replenishes the saturated groundwater layer through large pores under the influence of gravity, so the infiltrated water does not immediately cause a rise in groundwater level. Only when the water storage in the inactive water-bearing layer reaches the gravitational drainage threshold, i.e., when all water in the soil moves completely under the influence of gravity in the form of free water, due to vertical drainage and lateral water movement in the watershed, a groundwater level in some areas of the watershed rises to the surface to become a saturated surface. The resulting runoff occurs in two ways: saturation overland flow and interflow (also known as base flow). The saturation overland flow is formed on saturated slopes with poor soil hydraulic conductivity, gentle slopes, and convergent topography; and the interflow is formed in the saturated layer of soil.

In some embodiments, the step S100 may include, but is not limited to, a plurality of sub-steps S110 to S140.

At the sub-step S110, a potential evaporation is obtained based on an actual water evaporation in the target watershed.

At the sub-step S120, the water storage in the vegetation root zone is obtained.

At the sub-step S130, a maximum moisture capacity of the vegetation root zone at any point within the target watershed is obtained.

At the sub-step S140, the actual evaporation is obtained based on the potential evaporation, the water storage in the vegetation root zone, and the maximum moisture capacity.

In the sub-steps S110 to S140 of some embodiments, evaporation occurs in the vegetation root zone. For example, at any point i within the target watershed, the expression for actual evaporation is:

$${E}_{a , i} = {E}_{p} ( 1 - \frac{{S}_{rz , i}}{{S}_{r max , i}} ) ; \qquad ( 1 )$$

where E_{a, i} represents the actual evaporation at point i within the target watershed; Eₚ represents the potential evaporation, which can be obtained by referencing the actual water evaporation within the target watershed; S_{rz, i} represents the water storage in the vegetation root zone; and S_{r max, i} represents the maximum moisture capacity of the vegetation root zone at point i within the target watershed.

In some embodiments, the step S200 may include, but is not limited to, a plurality of sub-steps S210 to S270.

At the sub-step S210, a matric suction at any depth of soil is obtained based on a vertical distance from the any depth of soil to the slope surface, a matric suction at the wetting front, and the vertical distance from the wetting front to the slope surface.

At the sub-step S220, a first expression for water storage of soil mass at any depth in a wetted zone is obtained based on the infiltration model and the matric suction at any depth of soil.

At the sub-step S230, a first cumulative infiltration from rainfall is obtained based on the first expression for water storage of soil mass.

At the sub-step S240, a second expression for water storage of soil mass at any depth in the wetted zone is obtained based on the water storage at the wetting front and the first expression for water storage of soil mass.

At the sub-step S250, a second cumulative infiltration is obtained based on the first cumulative infiltration and the second expression for water storage of soil mass.

At the sub-step S260, an infiltration rate is obtained based on the second cumulative infiltration; and

At the sub-step S270, the total infiltration rate in the unsaturated zone is obtained based on the infiltration rate through a weighted averaging method.

In the sub-steps S210 to S270 of some embodiments, the infiltration can be calculated using an improved VG infiltration model. For example, the expression for the VG model is:

$$S = {S}_{r} + \frac{{S}_{s} - {S}_{r}}{{[ 1 + {( α h )}^{n} ]}^{m}} ; \qquad ( 2 )$$

where S represents water storage of soil mass at a point of interest; Sᵣ represents residual volumetric water storage of soil mass; Sₛ represents saturated volumetric water storage of soil mass; h represents matric suction of soil mass; and α, n, and m represent fitting parameters.

The expression for matric suction at any depth of soil is as follows:

$${h}_{z} = \frac{{h}_{f}}{{z}_{f}} z ; \qquad ( 3 )$$

where h_{z} represents the matric suction at any depth of soil; h_{f} represents the matric suction at the wetting front; Z_{f} represents the vertical distance from the wetting front to the slope surface; and Z represents the vertical distance from any depth of soil to the slope surface.

The first expression for water storage of soil mass at any depth in the wetted zone is obtained by substituting equation (3) into equation (2), as follows:

$$S ( z ) = {S}_{r} + \frac{{S}_{s} - {S}_{r}}{{[ 1 + {( \frac{α {h}_{f}}{{z}_{f}} z )}^{n} ]}^{m}} ; \qquad ( 4 )$$

where S(z) represents water storage of soil mass.

Based on the first expression for water storage of soil mass and the initial water storage of dry soil layer, the expression for the first cumulative infiltration from rainfall can be obtained as follows:

$$I = {\int }_{0}^{z} [ S ( z ) - {S}_{i} ] dz ; \qquad ( 5 )$$

where I represents the first cumulative infiltration; and Sᵢ represents initial water storage of dry soil layer.

Equation (4) is substituted into equation (5) to yield:

$$I = ( {S}_{r} - {S}_{i} ) {z}_{f} + ( {S}_{s} - {S}_{r} ) {\int }_{0}^{{z}_{f}} \frac{1}{{[ 1 + {( \frac{α {h}_{f}}{{z}_{f}} z )}^{n} ]}^{m}} dz ; \qquad ( 6 )$$

where the second term

$$( {S}_{s} - {S}_{r} ) {\int }_{0}^{{z}_{f}} \frac{1}{{[ 1 + {( \frac{α {h}_{f}}{{z}_{f}} z )}^{n} ]}^{m}} dz$$

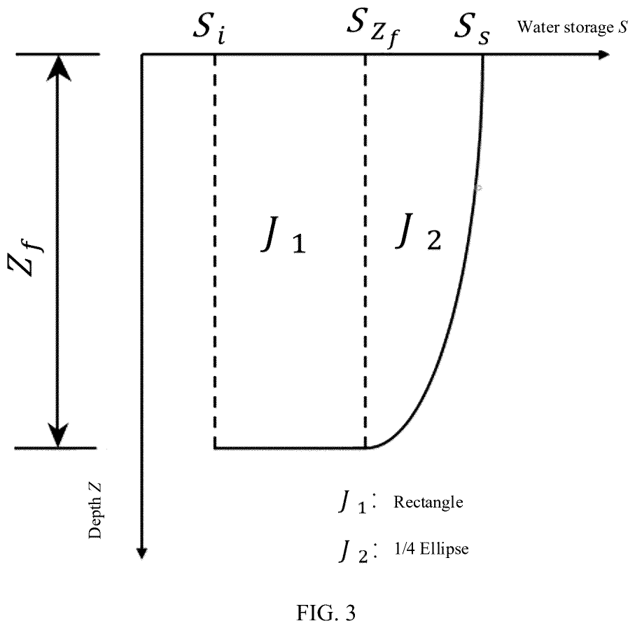

on the right side of equation (6) is an indefinite integral expression. For convenience in solving, equation (6) is simplified for calculation. As shown in FIG. 3, a distribution of water storage along depth in the slope profile can be obtained based on equation (4). The water storage profile distribution is simplified into a combination of shape J₁ and shape J₂, delineated by the water storage at the wetting front, where shape J₁ is assumed to be a rectangle, while shape J₂ is assumed to be a ¼ ellipse.

In some embodiments, through experiments measuring water storage of red-bed soft rock soil mass, the water storage at the wetting front can be obtained, for example, substituting z=z_{f} into equation (4), the expression for water storage at the wetting front can be obtained as follows:

$${S}_{{z}_{f}} = {S}_{r} + \frac{{S}_{s} - {S}_{r}}{{[ 1 + {( α {h}_{f} )}^{n} ]}^{m}} ; \qquad ( 7 )$$

where S_{Z}_{_{f}} represents the water storage at the wetting front.

Based on the simplified combination of the shapes of profile water storage, the second expression for water storage of soil mass at any depth in the wetted zone can be obtained as follows:

$$S ( z ) = \{ \begin{matrix}{S}_{{z}_{f}} + ( {S}_{s} - {S}_{{z}_{f}} ) \sqrt{1 - {( \frac{z}{{z}_{f}} )}^{2}} , z \leq {z}_{f} \\ {S}_{i} , z > {z}_{f}\end{matrix} . \qquad ( 8 )$$

Based on the first cumulative infiltration and the second expression for water storage of soil mass, that is, substituting equation (8) into equation (5), the expression for the second cumulative infiltration can be obtained as follows:

$$QI = ( {S}_{{z}_{f}} - {S}_{i} ) {z}_{f} + \frac{π}{4} ( {S}_{s} - {S}_{{z}_{f}} ) {z}_{f} ; \qquad ( 9 )$$

where QI represents the second cumulative infiltration.

The expression for infiltration rate can be obtained by taking the derivative of the expression for the second cumulative infiltration, that is, taking the derivative of equation (9), as follows:

$${q}_{v} = ( {S}_{{z}_{f}} - {S}_{i} ) \frac{d ( {z}_{f} )}{dt} + \frac{π}{4} ( {S}_{s} - {S}_{{z}_{f}} ) \frac{d ( {z}_{f} )}{dt} ; \qquad ( 10 )$$

where qᵥ represents the infiltration rate.

Based on the infiltration rate, the expression for total infiltration rate of the unsaturated zone can be obtained through a weighted averaging method as follows:

$${Q}_{v} = {\sum }_{i} {q}_{v , i} \cdot {A}_{i} ; \qquad ( 11 )$$

where Qᵥ represents the total infiltration rate of the unsaturated zone; q_{v, i} represents a soil infiltration rate at point i; and Aᵢ represents a sum of areas of all points having an identical topographic index on the target watershed.

In some embodiments, the flash flood simulation method applicable to red-bed soft rock regions further includes a plurality of sub-steps S810 to S880:

At the sub-step S810, a first preset condition, a second preset condition, and a third preset condition are set.

At the sub-step S820, a watershed runoff generation rate and a unit-width catchment area are obtained based on the first preset condition.

At the sub-step S830, a first expression of interflow velocity is obtained based on the watershed runoff generation rate and the unit-width catchment area.

At the sub-step S840, a hydraulic conductivity at any point and a surface slope at the any point are obtained based on the second preset condition.

At the sub-step S850, a second expression of interflow velocity is obtained based on the hydraulic conductivity and the surface slope at the any point are obtained.

At the sub-step S860, a saturated hydraulic conductivity of soil and a maximum water storage depth of the unsaturated zone based on the third preset condition;

At the sub-step S870, a functional relationship between the saturated hydraulic conductivity of soil and the vertical distance from the wetting front to the slope surface is obtained based on the saturated hydraulic conductivity of soil and the maximum water storage depth.

At the sub-step S880, the vertical distance from the wetting front to the slope surface is obtained based on the first expression of interflow velocity, the second expression of interflow velocity, and the functional relationship.

In the sub-step S810 of some embodiments, the first preset condition specifies that the interflow in a water-bearing layer is in a stable state, and a unit-width interflow rate at any point in the target watershed is equal to an upstream inflow discharge; the second preset condition specifies that a difference between a hydraulic gradient of saturated groundwater and the surface slope is less than one percent of an absolute value of the surface slope; and the third preset condition specifies that the saturated hydraulic conductivity of soil is negatively correlated with the vertical distance from the wetting front to the slope surface.

In the sub-steps S820 to S870 of some embodiments, to determine the depth from the saturated groundwater table to the ground surface at a certain point in the target watershed, that is, the vertical distance from the wetting front to the slope surface in the infiltration model, three predefined conditions are pre-set:
(a) First preset condition: It is assumed that that the interflow in the water-bearing layer is always in a stable state, and the unit-width interflow rate at any point in the target watershed is equal to the upstream inflow discharge.

Under the first preset condition, the watershed runoff generation rate and the unit-width catchment area are obtained, thus the first expression for interflow velocity is as follows:

$${v}_{i} = R \cdot {a}_{i} ; \qquad ( 12 )$$

where vᵢ represents the interflow velocity at point i within the target watershed; R represents watershed runoff generation rate, which is assumed uniformly distributed across the entire watershed; and aᵢ represents unit-width catchment area.
(b) Second preset condition: It is assumed that that the hydraulic gradient of saturated groundwater is approximately equal to the surface slope.

Under the second preset condition, the hydraulic conductivity at any point and the surface slope at the any point are obtained; and according to Darcy's law, the second expression for interflow velocity is as follows:

$${v}_{i} = {T}_{i} tan {β}_{i} ; \qquad ( 13 )$$

where Tᵢ represents the hydraulic conductivity at point i within the target watershed; and βᵢ represents surface slope of point i within the target watershed.
(c) Third preset condition: It is assumed that the saturated hydraulic conductivity of soil is correlated to the vertical distance from the wetting front to the slope surface (i.e., the depth to saturated groundwater table) in an exponential function.

Under the third preset condition, based on the saturated hydraulic conductivity of soil and the maximum water storage depth of the unsaturated zone, the following functional relationship is established:

$${T}_{i} = {T}_{0} exp ( - {z}_{f} / {S}_{zm} ) ; \qquad ( 14 )$$

where T₀ represents the saturated hydraulic conductivity of soil; and S_{zm} represents the maximum water storage depth of the unsaturated zone.

In the sub-step S880 of some embodiments, based on the first preset condition, the second preset condition, and the third preset condition, by combining equations (12), (13), and (14), the following expression can be obtained:

$$R \cdot {a}_{i} = {T}_{0} \cdot tan {β}_{i} \cdot exp ( - {z}_{f} / {S}_{zm} ) . \qquad ( 15 )$$

Based on equation (15), the following can be obtained:

$${z}_{f} = - {S}_{zm} \cdot ln ( \frac{{a}_{i} \cdot R}{{T}_{0} \cdot tan {β}_{i}} ) . \qquad ( 16 )$$

Therefore, the expression for the average saturated groundwater table depth across the entire watershed can be:

$$\overline{z} = \frac{1}{A} {\int }_{A} {z}_{f} dA = \frac{{S}_{zm}}{A} {\int }_{A} [ - ln ( \frac{{a}_{i}}{{T}_{0} \cdot tan {β}_{i}} ) - ln R ] dA ; \qquad ( 17 )$$

where z̅ represents the average saturated groundwater table depth of the entire watershed; and A represents the area of the watershed.

By combining equations (16) and (17), the following expression can be obtained:

$$\overline{z} = {S}_{zm} \cdot [ - \frac{1}{A} {\int }_{A} ln ( \frac{{a}_{i}}{{T}_{0} \cdot tan {β}_{i}} ) dA + \frac{{z}_{f}}{{S}_{zm}} + ln ( \frac{{a}_{i}}{{T}_{0} \cdot tan {β}_{i}} ) ] . \qquad ( 18 )$$

Equation (18) can be rearranged to yield the following expression:

$${z}_{f} = \overline{z} - {S}_{zm} \cdot [ ln ( \frac{{α}_{i}}{tan {β}_{i}} ) - λ ] ; \qquad ( 19 )$$

where

$$λ = \frac{1}{A} {\int }_{A} ln ( \frac{{a}_{i}}{{T}_{0} \cdot tan {β}_{i}} ) dA ,$$

in which λ represents a first intermediate parameter.

In some embodiments, the saturated hydraulic conductivity of soil is assumed to be uniformly distributed across the entire watershed, the saturated hydraulic conductivity of soil in equation (19) will be eliminated, resulting in the following expression:

$${z}_{f} = \overline{z} - {S}_{zm} \cdot [ ln ( \frac{{a}_{i}}{tan {β}_{i}} ) - {λ}^{*} ] ; \qquad ( 20 )$$

where

$${λ}^{*} = \frac{1}{A} {\int }_{A} ln ( \frac{{a}_{i}}{tan {β}_{i}} ) dA ,$$

in which λ* represents a second intermediate parameter.

From equation (20), it can be known that the depth to saturated groundwater table at a certain point in the target watershed z_{f} is determined solely by the topographic index

$$ln ( \frac{{a}_{i}}{tan {β}_{i}} )$$

at that point.

In some embodiments, the step S300 may include, but is not limited to, a plurality of sub-steps S310 to S320:

At the sub step S310, the saturation overland flow is determined when the vertical distance from the wetting front to the slope surface is less than zero and hence exfiltration of saturated groundwater occurs; and

At the sub step S320, the interflow is obtained based on the vertical distance from the wetting front to the slope surface, the saturated hydraulic conductivity of soil, the surface slope, and the maximum water storage depth.

In the sub-step S310 of some embodiments, the depth to saturated groundwater table in the target watershed can be determined based on equation (20). If z_{f}<0, then the exfiltration of saturated groundwater occurs, forming saturation overland flow. Therefore, the expression of saturation overland flow is:

$${Q}_{s} = \frac{1}{Δ t} \sum max \{ [ {S}_{uz , í} - max [ {z}_{f} , 0 ] ] , 0 \} {A}_{i} ; \qquad ( 21 )$$

where Qₛ represents saturation overland flow; Δt represents time step size; and S_{uz,i} represents water storage at point i in the unsaturated zone.

In the sub-step S320 of some embodiments, the expression of interflow can be:

$${Q}_{b} = {\int }_{L} {q}_{v , i} d L = {\int }_{L} {T}_{0} tan {β}_{i} exp ( - {z}_{f} / {S}_{zm} ) d L . \qquad ( 22 )$$

By combining equations (20) and (22), the following expression can be obtained:

$${Q}_{b} = {\int }_{L} {T}_{0} tan {β}_{i} exp [ - \overline{z} / {S}_{zm} - {λ}^{*} + ln ( \frac{{a}_{i}}{tan {β}_{i}} ) ] = {T}_{0} exp ( - \overline{z} / {S}_{zm} ) exp ( - {λ}^{*} ) {\int }_{L} {a}_{i} dL . \qquad ( 23 )$$

Due to ∫_{L}aᵢdL=A, equation (23) can be expressed as:

$${Q}_{b} = {T}_{0} exp ( - \overline{z} / {S}_{zm} ) exp ( - {λ}^{*} ) \cdot A = {Q}_{0} exp ( - \overline{z} / {S}_{zm} ) ; \qquad ( 24 )$$

where Q₀=AT₀ exp(−λ*), in which q_{v,i} represents the soil infiltration rate at point i; Q_{b} represents the interflow; and Q₀ represents the interflow when the average saturated groundwater table depth of the entire watershed z̅ is zero.

In some embodiments, the flash flood simulation method applicable to red-bed soft rock regions further includes a following step.

At a step S900, an initial average saturated groundwater table depth before rainfall id obtained based on an initial interflow of the target watershed and the maximum water storage depth of the unsaturated zone.

In the step S900 of some embodiments, assuming that there is no rainfall for a long period, and only interflow exists in the watershed outflow, the following expression can be obtained:

$${Q}_{b}^{1} = {Q}_{0} exp ( - {\overline{z}}^{1} / {S}_{zm} ) . \qquad ( 25 )$$

Therefore, the expression for the initial average saturated groundwater table depth of the entire watershed before the onset of rainfall can be obtained as:

$${\overline{z}}^{1} = - {S}_{zm} \cdot ln ( {Q}_{b}^{1} / {Q}_{0} ) ; \qquad ( 26 )$$

where

$${Q}_{b}^{1}$$

represents the initial interflow of the target watershed; and z̅¹ represents the initial average saturated groundwater table depth during the pre-rainfall period, which is the first average groundwater depth before rainfall.

In some embodiments, the step S400 may include, but is not limited to, a sub-step S410.

In the sub-step S410, an average saturated groundwater table depth at a next time point is obtained based on a total infiltration rate of the unsaturated zone at a current time point, the interflow at the current time point, and the average saturated groundwater table depth at the current time point.

In the sub-step S410 of some embodiments, due to the vertical downward movement of free water in the unsaturated water-bearing layer under the influence of gravity and the lateral movement of interflow, the average saturated groundwater table depth of the entire watershed changes over time. Therefore, it is necessary to update it at the end of each time interval. If the end of the current time interval is the current time point/and the end of the next time interval is the next time point t+1, the following expression can be obtained:

$${\overline{z}}^{t + 1} = {\overline{z}}^{t} - \frac{( {Q}_{v}^{t} - {Q}_{b}^{t} )}{A} Δ t ; \qquad ( 27 )$$

where z̅^{t} represents the average saturated groundwater table depth at time point t, which is the average saturated groundwater table depth at the current time point t; z̅^{t+1} represents the average saturated groundwater table depth at time point t+1, which is the average saturated groundwater table depth at the next time point t+1;

$${Q}_{v}^{t}$$

represents the total infiltration rate of the unsaturated zone at the current time point t, which is the total infiltration rate of the unsaturated zone at the current time point t; and

$${Q}_{b}^{t}$$

represents the interflow at time point t, which is the interflow at the current time point t.

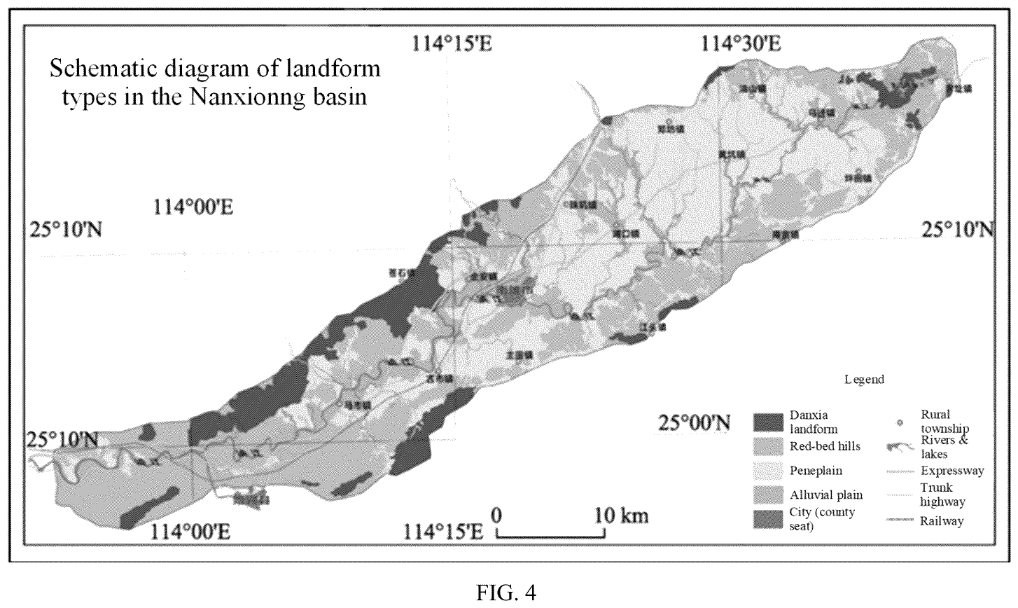

For example, as shown in FIG. 4, the Nanxiong red-bed basin is selected as the experimental region. The Nanxiong red-bed basin is located in Nanxiong City, Shaoguan City, Guangdong Province. Nanxiong City possesses superior natural conditions and belongs to the subtropical monsoon humid climate zone, characterized by relatively high temperatures, abundant thermal energy, and substantial rainfall. It is rich in resources including agriculture, animal husbandry, fisheries, forestry, water resources, mineral resources, and tourism resources. The total area of the entire city is 2,326.18 km², with the Nanxiong Red Bed Basin covering approximately 1,800 km² which starts from Jilongwei in Shixing County in the west and connects with the Xinfeng basin in the east, with a longitudinal length of about 100 km and a maximum north-south width not exceeding 20 km. The terrain features higher elevations in the north and south, a lower central area, forming an elongated basin stretching northeast-southwest. The basin consists of hilly terrain formed by red strata, generally exhibiting elevation differences below 50 m and relatively gentle undulations. The Zhenjiang River flows westward through the center of the basin. Its landform is shown in FIG. 4.

The central region of the Nanxiong red-bed basin features widely distributed soft rock hills and ridges, with a high storage of clay minerals and easily soluble salts, weak cementation, and other characteristics. The rocks have a weak resistance to weathering, making them susceptible to weathering, fragmentation, and erosion by flowing water. In addition, due to development and utilization, the original ecological structure of the surface in the red strata distribution area has been damaged, leading to rapid erosion of the soil layer, exposing the red-bed rock or its weathered shell, resulting in a red desert landscape and severe soil and water loss.

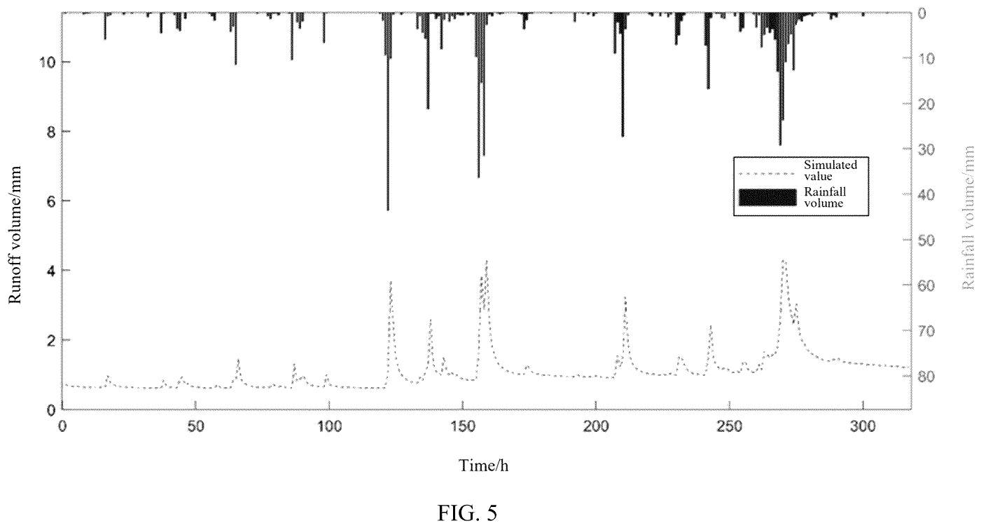

Typical event-based floods in the experimental region are selected for simulation, and the water storage at the wetting front in the experimental region is obtained through multiple experiments. Based on the aforementioned calculation principles, the actual evaporation, total infiltration rate of the unsaturated zone, saturation overland flow, interflow, and target average groundwater depth are obtained, a flash flood model for the target watershed is constructed, and the event-based flood hydrograph for the target watershed is simulated based on the flash flood model to obtain simulation results as shown in FIG. 5.

An embodiment of the present disclosure further provides a flash flood simulation device applicable to red-bed soft rock regions, which can implement the aforementioned flash flood simulation method applicable to red-bed soft rock regions, the device including a plurality of following modules.
a first module configured to obtain a water storage in a vegetation root zone, and obtain an actual evaporation at any point in the vegetation root zone within a target watershed;
a second module configured obtain a total infiltration rate in an unsaturated zone based on an infiltration model;
a third module configured to obtain a saturation overland flow and an interflow based on a vertical distance from a wetting front to a slope surface;
a fourth module configured to update an average saturated groundwater table depth at the end of each time interval based on the interflow and the total infiltration rate of the unsaturated zone;
a fifth module configured to construct a flash flood model for the target watershed based on the water storage of the vegetation root zone, the actual evaporation, the total infiltration rate of the unsaturated zone, the saturation overland flow, the interflow, and the average saturated groundwater table depth at the end of each time interval; and
a sixth module configured to simulate an event-based flood hydrograph of the target watershed based on the flash flood model for the target watershed to obtain simulation results.

It can be understood that the storages in the above method embodiments are all applicable to this device embodiment. The specific functions achieved by this device embodiment are the same as those of the above-described method embodiments, and the beneficial effects achieved are also the same as those of the above-described method embodiments.

A further embodiment of the present disclosure provides an electronic device, including a processor and a memory, where the memory stores a computer program which, when executed by the processor, causes the processor to perform the aforementioned flash flood simulation method applicable to red-bed soft rock regions. The electronic device may be any intelligent terminal device, including tablet computers, onboard computers, etc.

It can be understood that the storages in the above method embodiments are all applicable to this device embodiment, and the specific functions achieved by the embodiment of the device are the same as those of the above-described method embodiments, and the beneficial effects achieved are also the same as those of the above-described method embodiments.

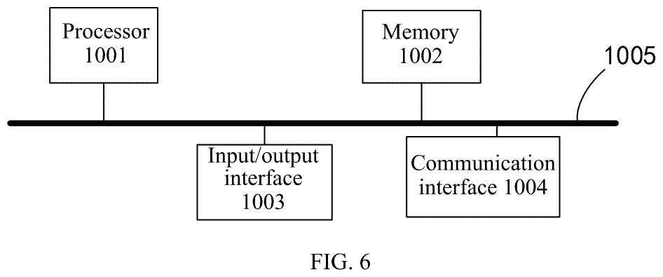

Refer to FIG. 6. it illustrates the hardware structure of an electronic device according to another embodiment. The electronic device includes:
a processor 1001, which may be implemented by a general-purpose central processing unit (CPU), a microprocessor, an application-specific integrated circuit (ASIC), or one or more integrated circuits, and is configured to execute related programs to implement the technical schemes provided by the embodiments of the present disclosure;
a memory 1002, which may be implemented in forms such as read-only memory (ROM), static storage devices, dynamic storage devices, or random access memory (RAM), where the memory 1002 may store an operating system and other applications, and when the technical schemes provided by the embodiments of this specification are implemented by software or firmware, the related program code stored in the memory 1002 is called and executed by the processor 1001 to perform the flash flood simulation method applicable to red-bed soft rock regions of any one of the embodiments of the present disclosure;
an input/output interface 1003 for realizing information input and output;
a communication interface 1004 for realizing communication and interaction between this device and other devices, which may be achieved through wired methods (such as USB, network cables, etc.) or wireless methods (such as mobile networks, Wi-Fi, Bluetooth, etc.); and
a bus 1005 for transmitting information between various components (such as the processor 1001, memory 1002, input/output interface 1003, and communication interface 1004) of the device.

Herein, the processor 1001, the memory 1002, the input/output interface 1003, and the communication interface 1004 communicate with each other within the device via the bus 1005.

A further embodiment of the present disclosure provides a computer-readable storage medium storing a computer program which, when executed by a processor, causes the processor to perform the aforementioned flash flood simulation method applicable to red-bed soft rock regions.

It can be understood that the storages in the above method embodiments are all applicable to this storage medium embodiment, and the specific functions achieved by the embodiment of the storage medium are the same as those of the above-described method embodiments, and the beneficial effects achieved are also the same as those of the above-described method embodiments.

A further embodiment of the present disclosure provides a computer program product or computer program including computer instructions stored in a computer-readable storage medium. The processor of the computer device can read the computer instructions from the computer-readable storage medium, and the processor executes the computer instructions to cause the computer device to perform the aforementioned flash flood simulation method applicable to red-bed soft rock regions.

In summary, the flash flood simulation method applicable to red-bed soft rock regions according to the embodiments of the present disclosure has the following advantages.
1. The embodiments of the present disclosure improve the accuracy of flash flood forecasting by measuring and fitting soil infiltration characteristics in red-bed soft rock regions, and dynamically adjusting hydrological model parameters, thereby enabling accurate description of infiltration and surface runoff processes during rainfall in red-bed soft rock regions prone to flash floods.
2. The embodiments of the present disclosure addresses the special geological conditions of red-bed soft rock regions by introducing specific correction parameters into the infiltration module of the semi-distributed hydrological model, including water storage at the wetting front, saturated water storage of soil mass, depth to saturated groundwater table, etc., thereby enabling the model to accurately reflect the geological characteristics and hydrological processes of the regions.

In some optional embodiments, the functions/operations mentioned in the block diagram may not be performed in the order mentioned in the operation diagram. For example, depending on the functions/operations involved, two blocks shown in succession may in fact be performed substantially simultaneously or the two blocks may sometimes be performed in reverse order. Further, the embodiment presented and described in the flow chart of the present disclosure are provided by way of example in order to provide a more comprehensive understanding of the techniques. The disclosed method is not limited to the operations and logical flows presented herein. Optional embodiments are contemplated in which the order of various operations is changed and in which sub-operations described as part of a larger operation are performed independently.

Furthermore, although the present disclosure has been described in the context of functional modules, it should be understood that, unless otherwise stated, one or more functionalities and/or features may be integrated into a single physical device and/or software module, or one or more functionalities and/or features may be implemented in separate physical devices or software modules. It can also be understood that a detailed discussion of the actual implementation of each module is unnecessary for understanding the present disclosure. More precisely, in light of the attributes, functionalities, and internal relationships of various functional modules disclosed herein, those skilled in the art will understand the actual implementation of these modules within the routine skills of an engineer. Therefore, those skilled in the art can implement the aspects of the present disclosure as set forth in the claims using ordinary techniques without excessive experimentation. It can also be understood that the specific concepts disclosed are merely illustrative and are not intended to limit the scope of the present disclosure, which is defined by the full scope of the appended claims and their equivalents.

If the functions are implemented in the form of functional units of software and sold or used as independent products, they can be stored in a computer-readable storage medium. On the basis of this understanding, the substance or the parts that contribute to the existing technology or a part of the technical schemes of the present disclosure may be embodied in the form of a software product, which is stored in a storage medium and includes a number of instructions to cause a computer device (which can be a personal computer, a server, or a network device, etc.) to execute all or part of the steps of the method described in the embodiments of the present disclosure. The aforementioned storage medium includes: various media that can store program codes, such as a USB flash drive, a mobile hard disk, a read-only memory (ROM), a random access memory (RAM), a magnetic disk or an optical disk.

The logic and/or steps represented in the flowchart or described herein in other ways may be regarded as a sequential list of executable instructions for implementing logical functions, which can be specifically embodied in any computer-readable medium for use by instruction execution systems, apparatuses, or devices (such as a computer-based system, a system including a processor, or any other system that can fetch and execute instructions from an instruction execution system, apparatus, or device), or in conjunction with these instruction execution systems, apparatuses, or devices. For the purposes of this specification, “computer-readable medium” may be any device that can contain, store, communicate, propagate, or transmit programs for use by instruction execution systems, apparatuses, or devices or in conjunction with these instruction execution systems, apparatuses, or devices.

More specific examples of computer-readable media (non-exhaustive list) include the following: an electrical connection having one or more wires (electronic devices), portable computer diskette (magnetic devices), random-access memory (RAM), read-only memory (ROM), erasable programmable read-only memory (EPROM or Flash memory), optical fiber devices, and portable compact disc read-only memory (CD-ROM). Additionally, a computer-readable medium may even be paper or other suitable media on which programs can be printed, as programs can be electronically obtained, for example, by optically scanning the paper or other media, followed by editing, interpreting, or processing in another suitable manner as necessary, and then storing them in a computer memory.

It should be understood that the various parts of the present disclosure may be implemented in hardware, software, firmware, or a combination thereof. In the above implementations, a plurality of steps or methods may be implemented using software or firmware that is stored in memory and executed by a suitable instruction execution system. For example, if implemented with hardware, as in another implementation, any one of the following techniques known in the art or their combinations may be used: discrete logic circuits with logic gate circuits for implementing logical functions on data signals, application specific integrated circuits with suitable combinational logic gate circuits, programmable gate arrays (PGA), field programmable gate arrays (FPGA), etc.

In this specification, the description with reference to terms such as “one embodiment”, “some embodiments”, “example”, “specific example”, and “some examples” means that the specific features, structures, materials or features described in conjunction with the embodiment(s) or example(s) are included in at least one embodiment or example of the present disclosure. In the description, the illustrative expressions of the above-mentioned terms do not necessarily refer to the same embodiments or examples. Moreover, the specific features, structures, materials or characteristics described can be combined in any one or more embodiments or examples in any suitable manner.

Although the embodiments of the present disclosure have been shown and described, it can be understood by those of ordinary skill in the art that various changes, modifications, substitutions and variations may be made to these embodiments without departing from the principles and objectives of the present disclosure, and the scope of the present disclosure is defined by the claims and their equivalents.

The above is a detailed description of the preferred implementation of the present disclosure, but the present disclosure is not limited to the above-mentioned embodiments. Those of ordinary skill in the art can also make various equivalent modifications or replacements without departing from the spirit of the present disclosure, and these equivalent modifications or replacements are all included in the scope defined by the claims of the present disclosure.

1. A flash flood simulation method applicable to red-bed soft rock regions, comprising:
obtaining a water storage in a vegetation root zone and obtaining an actual evaporation at any point in the vegetation root zone within a target watershed;
obtaining a total infiltration rate in an unsaturated zone of soil based on an infiltration model;
obtaining a saturation overland flow and an interflow based on a vertical distance from a wetting front to a slope surface;
updating an average saturated groundwater table depth at an end of each time interval based on the interflow and the total infiltration rate of the unsaturated zone of soil;
constructing a flash flood model for the target watershed based on the water storage of the vegetation root zone, the actual evaporation, the total infiltration rate of the unsaturated zone, the saturation overland flow, the interflow, and the average saturated groundwater table depth at the end of each time interval; and
simulating an event-based flood hydrograph of the target watershed based on the flash flood model for the target watershed to obtain simulation results;
wherein obtaining a total infiltration rate in an unsaturated zone based on an infiltration model comprises:
obtaining a matric suction at any depth of soil based on a vertical distance from the any depth of soil to the slope surface, a matric suction at the wetting front, and the vertical distance from the wetting front to the slope surface;
obtaining a first expression for water storage of soil mass at any depth in a wetted zone based on the infiltration model and the matric suction at any depth of soil;
obtaining a first cumulative infiltration from rainfall based on the first expression for water storage of soil mass;
obtaining a second expression for water storage of soil mass at any depth in the wetted zone based on a water storage at the wetting front and the first expression for water storage of soil mass;
obtaining a second cumulative infiltration based on the first cumulative infiltration and the second expression for water storage of soil mass;
obtaining an infiltration rate based on the second cumulative infiltration; and
obtaining the total infiltration rate in the unsaturated zone of soil based on a weighted averaging of the infiltration rate, wherein
an expression of the infiltration model is:
$$S = {S}_{r} + \frac{{S}_{s} - {S}_{r}}{{[ 1 + {( α h )}^{n} ]}^{m}} ;$$
the first expression for water storage of soil mass at any depth in the wetted zone is:
$$S ( z ) = {S}_{r} + \frac{{S}_{s} - {S}_{r}}{{[ 1 + {( \frac{α {h}_{f}}{{z}_{f}} z )}^{n} ]}^{m}} ;$$
an expression of the first cumulative infiltration is:
$$I = {\int }_{0}^{z} [ S ( z ) - {S}_{i} ] dz ;$$
the second expression for water storage of soil mass at any depth in the wetted zone is:
$$S ( z ) = \{ \begin{matrix}{S}_{{z}_{f}} + ( {S}_{s} - {S}_{{z}_{f}} ) \sqrt{1 - {( \frac{z}{{z}_{f}} )}^{2}} , z \leq {z}_{f} ; \\ {S}_{i} , z > {z}_{f}\end{matrix}$$
the second cumulative infiltration is:
$$QI = ( {S}_{{z}_{f}} - {S}_{i} ) {z}_{f} + \frac{π}{4} ( {S}_{s} - {S}_{{z}_{f}} ) {z}_{f} ;$$
an expression of the infiltration rate is:
$${q}_{v} = ( {S}_{{z}_{f}} - {S}_{i} ) \frac{d ( {z}_{f} )}{dt} + \frac{π}{4} ( {S}_{s} - {S}_{{z}_{f}} ) \frac{d ( {z}_{f} )}{dt} ;$$
and
an expression of the total infiltration rate in the unsaturated zone of soil is:
$${Q}_{v} = {\sum }_{i} {q}_{v , i} \cdot {A}_{i} ,$$
in which S represents water storage of soil mass at a point of interest; h represents matric suction of soil mass; S(z) represents water storage of soil mass; Sᵣ represents residual volumetric water storage of soil mass; Sₛ represents saturated volumetric water storage of soil mass; α, n, and m represent fitting parameters; h_{f} represents the matric suction at the wetting front; z_{f} represents the vertical distance from the wetting front to the slope surface; z represents the vertical distance from any depth of soil to the slope surface; I represents the first cumulative infiltration; Sᵢ represents initial water storage of dry soil layer; S_{Z}_{_{f}} represents the water storage at the wetting front; QI represents the second cumulative infiltration; qᵥ represents the infiltration rate; Qᵥ represents the total infiltration rate of the unsaturated zone of soil; q_{v,i} represents a soil infiltration rate at point i; and Aᵢ represents a sum of areas of all points having the same topographic index on the target watershed.

2. The flash flood simulation method applicable to red-bed soft rock regions of claim 1, further comprising:
dividing a soil water storage layer into the vegetation root zone, the unsaturated zone of soil, and a saturated groundwater zone.

3. The flash flood simulation method applicable to red-bed soft rock regions of claim 1, wherein obtaining an actual evaporation at any point in the vegetation root zone within a target watershed comprises:
obtaining a potential evaporation based on an actual water evaporation in the target watershed;
obtaining the water storage in the vegetation root zone;
obtaining a maximum moisture capacity of the vegetation root zone at any point within the target watershed; and
obtaining the actual evaporation based on the potential evaporation, the water storage in the vegetation root zone, and the maximum moisture capacity.

4. The flash flood simulation method applicable to red-bed soft rock regions of claim 1, further comprising:
obtaining the water storage at the wetting front through an experiment measuring water storage of red-bed soft rock soil mass.

5. The flash flood simulation method applicable to red-bed soft rock regions of claim 1, further comprising:
setting a first preset condition, a second preset condition, and a third preset condition;
obtaining a watershed runoff generation rate and a unit-width catchment area based on the first preset condition;
obtaining a first expression of interflow velocity based on the watershed runoff generation rate and the unit-width catchment area;
obtaining a hydraulic conductivity at any point and a surface slope at the any point based on the second preset condition;
obtaining a second expression of interflow velocity based on the hydraulic conductivity and the surface slope at the any point;
obtaining a saturated hydraulic conductivity of soil and a maximum water storage depth of the unsaturated zone of soil based on the third preset condition;
obtaining a functional relationship between the saturated hydraulic conductivity of soil and the vertical distance from the wetting front to the slope surface based on the saturated hydraulic conductivity of soil and the maximum water storage depth; and
obtaining the vertical distance from the wetting front to the slope surface based on the first expression of interflow velocity, the second expression of interflow velocity, and the functional relationship.

6. The flash flood simulation method applicable to red-bed soft rock regions of claim 5, wherein the first preset condition specifies that the interflow in a water-bearing layer is in a stable state, and a unit-width interflow rate at any point in the target watershed is equal to an upstream inflow discharge; the second preset condition specifies that a difference between a hydraulic gradient of saturated groundwater and the surface slope is less than one percent of an absolute value of the surface slope; and
the third preset condition specifies that the saturated hydraulic conductivity of soil is negatively correlated with the vertical distance from the wetting front to the slope surface.

7. The flash flood simulation method applicable to red-bed soft rock regions of claim 5, wherein obtaining a saturation overland flow and an interflow based on a vertical distance from a wetting front to a slope surface comprises:
obtaining the saturation overland flow in response to the vertical distance from the wetting front to the slope surface being less than zero which means exfiltration of saturated groundwater occurs; and
obtaining the interflow based on the vertical distance from the wetting front to the slope surface, the saturated hydraulic conductivity of soil, the surface slope, and the maximum water storage depth.

8. The flash flood simulation method applicable to red-bed soft rock regions of claim 1, further comprising:
obtaining an initial average saturated groundwater table depth before rainfall based on an initial interflow of the target watershed and the maximum water storage depth of the unsaturated zone of soil.

9. The flash flood simulation method applicable to red-bed soft rock regions of claim 1, wherein updating an average saturated groundwater table depth at the end of each time interval based on the interflow and the total infiltration rate of the unsaturated zone of soil comprises:
obtaining an average saturated groundwater table depth at a next time point based on a total infiltration rate of the unsaturated zone of soil at a current time point, the interflow at the current time point, and the average saturated groundwater table depth at the current time point.

10-20. (canceled)
